(19) United States
(12) Patent Application Publication
(10) Pub. No.: US 2024/0196979 A1
(43) Pub. Date: Jun. 20, 2024

(54) An Aerosol Generating Device and an Aerosol Generating System

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/572,613

(22) PCT Filed: Jul. 5, 2022
(86) PCT No.: PCT/EP2022/068580

§ 371 Date: Dec. 20, 2023

(30) Foreign Application Priority Data
Jul. 20, 2021 (EP) 21186654.6

(51) Int. Cl. A24F 40/465; A24F 40/20; A24F 40/57; H05B 6/06; H05B 6/10

(52) U.S. Cl. CPC A24F 40/465; A24F 40/20; A24F 40/57; H05B 6/06; H05B 6/108

(57) ABSTRACT

An aerosol generating device includes a controller and an induction heating arrangement configured to heat an aerosol generating substrate to generate an aerosol to be inhaled. The induction heating arrangement includes an induction coil including at least a plurality of first coil strands and a plurality of second coil strands and the controller is configured to control the induction heating arrangement to supply an alternating electric current to the plurality of first coil strands to generate a first electromagnetic field with a first frequency and to supply an alternating electric current to the plurality of second coil strands to generate a second electromagnetic field with a second frequency that is different from the first frequency. An aerosol generating system includes the aerosol generating device and an aerosol generating substrate.

### TECHNICAL FIELD

The present disclosure relates generally to an aerosol generating device, and more particularly to an aerosol generating device for heating an aerosol generating substrate to generate an aerosol for inhalation by a user. Embodiments of the present disclosure also relate to an aerosol generating system comprising an aerosol generating device and an aerosol generating substrate and to a method of using the aerosol generating system to generate an aerosol to be inhaled. The present disclosure is particularly applicable to a portable (hand-held) aerosol generating device. Such devices heat, rather than burn, an aerosol generating substrate, e.g., tobacco or other suitable materials, by conduction, convection, and/or radiation to generate an aerosol for inhalation by a user. The present disclosure is particularly concerned with an inductively heated aerosol generating device and/or system.

### TECHNICAL BACKGROUND

The popularity and use of reduced-risk or modified-risk devices (also known as aerosol generating devices or vapour generating devices or personal vaporizers) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by one or more of conduction, radiation and convection to the aerosol generating substrate and an aerosol is generated as the aerosol generating substrate is heated.

It is generally desirable to control the heat distribution within the aerosol generating substrate to ensure that an aerosol with acceptable characteristics is generated for inhalation by a user throughout a period of use (also known as a smoking session). Embodiments of the present disclosure seek to provide an improved user experience in which the characteristics of the generated aerosol are optimised through more accurate control of the heat distribution within the aerosol generating substrate.

### SUMMARY OF THE DISCLOSURE

According to a first aspect of the present disclosure, there is provided an aerosol generating device comprising:
a controller:
an induction heating arrangement configured to heat an aerosol generating substrate to generate an aerosol to be inhaled, the induction heating arrangement comprising an induction coil comprising at least a plurality of first coil strands and a plurality of second coil strands:
wherein the controller is configured to control the induction heating arrangement to supply an alternating electric current to the plurality of first coil strands to generate a first electromagnetic field with a first frequency and to supply an alternating electric current to the plurality of second coil strands to generate a second electromagnetic field with a second frequency that is different from the first frequency.

The aerosol generating device is configured to heat an aerosol generating substrate, without burning the aerosol generating substrate, to volatise at least one component of the aerosol generating substrate and thereby generate a heated vapour which cools and condenses to form an aerosol for inhalation by a user of the aerosol generating device. The aerosol generating device is typically a hand-held, portable, device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

By generating first and second electromagnetic fields with first and second frequencies that differ from each other, the present disclosure enables the heat distribution within an aerosol generating substrate to be carefully controlled, for example because the first electromagnetic field may cause preferential heating of a first inductively heatable susceptor and the second electromagnetic field may cause preferential heating of a second inductively heatable susceptor. Thus, selective (or “zonal”) heating of the aerosol generating substrate can be achieved. The use of a single induction coil comprising a plurality of first coil strands for generating the first electromagnetic field and a plurality of second coil strands for generating the second electromagnetic field provides an effective solution for generating the first and second electromagnetic fields and ensures that the aerosol generating device has a compact design.

Optional features will now be set out. These are applicable singly or in any combination with any aspect of the present disclosure.

The induction coil may comprise a first coil portion in which the plurality of first coil strands may be arranged and may comprise a second coil portion in which the plurality of second coil strands may be arranged. The induction coil may comprise a periphery defining a cross-sectional coil envelope, and the first and second coil portions may be arranged within the cross-sectional coil envelope. The provision of first and second coil portions ensures that the plurality of first coils strands and the plurality of second coil strands are separated from each other within the cross-sectional coil envelope.

The induction coil may comprise an outer insulator, which may surround both the first and second coil portions, and which may define the coil periphery.

The induction coil may have a first end and a second end, and both the first coil strands and the second coil strands may extend from the first end to the second end.

The first and second coil portions may be electrically isolated from each other. This ensures that there is no electrical contact between the plurality of first coils strands in the first coil portion and the plurality of second coil strands in the second coil portion.

The plurality of first coil strands may have a first cross-section and the plurality of second coil strands have a second cross-section which may differ from the first cross-section. The different first and second cross-sections facilitate the generation of the first and second electromagnetic fields with different first and second frequencies. For example, the plurality of first coil strands and the plurality of second coil strands may differ from each other in one or more of cross-sectional shape and cross-sectional area.

The alternating current supplied to the first coil strands may comprise a first alternating current and the alternating current supplied to the second coil strands may comprise a second alternating current. The first alternating current may be different to the second alternating current. The first coil strands may be the same as the second coil strands (e.g. in cross-section, diameter and material). Alternatively, the first coil strands may differ from the second coil strands (e.g. in cross-section, diameter and/or material, as discussed above).

The controller may be configured to sequentially supply the alternating electric current to the plurality of first coil strands and the plurality of second coil strands to sequentially generate the first and second electromagnetic fields. Thus, the first and second electromagnetic fields are not generated simultaneously, but instead at different times. This conveniently allows different regions or portions of an aerosol generating substrate to be sequentially heated, thus providing for controlled heat distribution within the aerosol generating substrate and, in particular, selective (or “zonal”) heating.

The controller may be configured to supply the (first) alternating electric current to the plurality of first coil strands for a first period of time to generate the first electromagnetic field for the first period of time and thereafter to supply the (second) alternating electric current to the plurality of second coil strands for a second period of time that follows the first period of time to generate the second electromagnetic field for the second period of time. The first electromagnetic field may cause preferential heating of a first inductively heatable susceptor during the first period of time and the second electromagnetic field may cause preferential heating of a second inductively heatable susceptor during the second period of time. Thus, the first inductively heatable susceptor may be heated to a higher temperature than the second inductively heatable susceptor during the first period of time whereas the second inductively heatable susceptor may be heated to a higher temperature than the first inductively heatable susceptor during the second period of time. Again, this provides for controlled heat distribution within the aerosol generating substrate and, in particular, provides for selective (or “zonal”) heating.

The aerosol generating device may comprise a heating chamber which may define a heating zone for receiving at least part of an aerosol generating substrate. The induction coil may be positioned adjacent to the heating chamber to generate the first and second electromagnetic fields within the heating zone. Thus, the aerosol generating substrate can be heated efficiently when positioned in the heating zone defined by the heating chamber.

The first electromagnetic field may be adapted to heat a first inductively heatable susceptor having a first resonant frequency and the second electromagnetic field may be adapted to heat a second inductively heatable susceptor having a second resonant frequency that is different from the first resonant frequency. The first electromagnetic field thus causes preferential heating of the first inductively susceptor and the second electromagnetic field causes preferential heating of the second inductively heatable susceptor. By using different resonant frequencies, selective (or “zonal”) heating of the aerosol generating substrate can be achieved.

Using different resonant frequencies permits selective (or “zonal”) heating of the aerosol generating substrate to be carried out by controlling the induction heating arrangement so that the plurality of first coil strands generate a first electromagnetic field with a first frequency that is substantially equal to the first resonant frequency of the first inductively heatable susceptor and so that the plurality of second coil strands generate a second electromagnetic field with a second frequency that is substantially equal to the second resonant frequency of the second inductively heatable susceptor. Generating an electromagnetic field (first or second electromagnetic field) with a frequency (first or second frequency) that is substantially equal to the resonant frequency (first or second resonant frequency) of a particular susceptor (first or second susceptor) will cause that susceptor to generate a heat amount. It may also cause one or more of the other susceptors (i.e., any susceptor that has a resonant frequency that is not substantially equal to the frequency of the generated electromagnetic field) to generate a heat amount that is typically less than the heat amount generated by the particular susceptor, and which may be zero or substantially zero. Any selective heating of a particular susceptor should not, therefore, be construed as meaning that the other susceptors are not heated at all, but only that the selective heating of the particular susceptor will typically be primarily responsible for the release of aerosol from aerosol generating substrate adjacent to the particular susceptor. The term “preferential heating” is used throughout the specification to define this type of heating.

The aerosol generating device comprises the first inductively heatable susceptor and the second inductively heatable susceptor. The first and second inductively heatable susceptors provide for rapid and controlled heating of the aerosol generating substrate, whilst at the same time maximising energy efficiency. By providing the first and second inductively heatable susceptors as part of the aerosol generating device rather than with the aerosol generating substrate as part of an aerosol generating article, the structure and manufacture of the aerosol generating article can be simplified.

The first and second inductively heatable susceptors may be positioned around the heating chamber within the heating zone to define, respectively, a first area within the heating zone and a second area within the heating zone. The induction coil may extend helically around the heating chamber. Thus, selective (or “zonal”) heating of the aerosol generating substrate may be achieved in the first and second areas. For example, a first portion of the aerosol generating substrate may be positioned in the first area and heated in the first area by the first inductively heatable susceptor and a second portion of the aerosol generating substrate may be positioned in the second area and heated in the second area by the second inductively heatable susceptor. By providing an induction coil which extends helically around the heating chamber, reliable heating of the first and second inductively heatable susceptors by the corresponding first and second electromagnetic fields can be assured.

The induction coil may comprise a Litz wire or a Litz cable. It will, however, be understood that other materials could be used.

The induction coil may be arranged to operate in use with a fluctuating electromagnetic field having a magnetic flux density of between approximately 20 mT and approximately 2.0T at the point of highest concentration.

The heating chamber may be substantially tubular and the first and second inductively heatable susceptors may be spaced around the periphery of the substantially tubular heating chamber. The heating chamber may be substantially cylindrical and the first and second inductively heatable susceptors may be circumferentially spaced around the substantially cylindrical heating chamber. Thus, the heating chamber may be configured to receive a substantially cylindrical aerosol generating substrate which may be advantageous as, often, aerosol generating substrates in the form of aerosol generating articles are packaged and sold in a cylindrical form.

The heating chamber may have a longitudinal axis defining a longitudinal direction. Each of the first and second inductively heatable susceptors may be elongate in the longitudinal direction of the heating chamber. Each of the first and second inductively heatable susceptors may have a length and a width and, in an embodiment, the length may be at least five times the width. The elongate first and second inductively heatable susceptors are heated efficiently in the presence of the first and second electromagnetic fields and the elongate shape ensures that the aerosol generating substrate is heated rapidly and uniformly along its length. The energy efficiency of the aerosol generating device is thereby maximised.

The heating chamber may comprise a substantially non-electrically conductive and non-magnetically permeable material. For example, the heating chamber may comprise a heat-resistant plastics material, such as polyether ether ketone (PEEK). The heating chamber itself is not heated by the induction heating arrangement during operation of the aerosol generating device, ensuring that energy input into the first and second inductively heatable susceptors is maximised. This in turn helps to ensure that the energy efficiency of the device is maximised. The device also remains cool to the touch, ensuring that user comfort is maximised.

The first and second inductively heatable susceptors may comprise a metal. The metal is typically selected from the group consisting of stainless steel and carbon steel. The first and second inductively heatable susceptors could, however, comprise any suitable material including one or more, but not limited, of aluminium, iron, nickel, stainless steel, carbon steel, and alloys thereof, e.g. Nickel Chromium or Nickel Copper. With the application of the first or second electromagnetic field in its vicinity, the corresponding first or second inductively heatable susceptor generates heat due to eddy currents and magnetic hysteresis losses resulting in a conversion of energy from electromagnetic to heat.

The aerosol generating device may include a power source and the controller may include control circuitry. The power source and control circuitry may be configured to operate at a high frequency. The power source and control circuitry may be configured to operate at a frequency of between approximately 80 KHz and 1 MHZ, possibly between approximately 150 kHz and 250 kHz, and possibly at approximately 200 kHz. The power source and control circuitry could be configured to operate at a higher frequency, for example in the MHz range, depending on the type of inductively heatable susceptors that are used. The power source and control circuitry may be configured to operate at a plurality of frequencies (e.g. at least two frequencies).

According to a second aspect of the present disclosure, there is provided an aerosol generating system comprising:
an aerosol generating substrate; and
an aerosol generating device as defined above for heating the aerosol generating substrate to generate an aerosol to be inhaled.

The aerosol generating substrate may comprise any type of solid or semi-solid material. Example types of aerosol generating solids include powder, granules, pellets, shreds, strands, particles, gel, strips, loose leaves, cut filler, porous material, foam material or sheets. The aerosol generating substrate may comprise plant derived material and in particular, may comprise tobacco. It may advantageously comprise reconstituted tobacco, for example including tobacco and any one or more of cellulose fibres, tobacco stalk fibres and inorganic fillers such as CaCO₃.

Consequently, the aerosol generating device may be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating substrate may form part of an aerosol generating article and may be circumscribed by a paper wrapper.

The aerosol generating article may be formed substantially in the shape of a stick, and may broadly resemble a cigarette, having a tubular region with an aerosol generating substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating substrate. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating substrate to cool and condense to form an aerosol with suitable characteristics for inhalation by a user, for example through the filter segment.

The aerosol generating substrate may comprise an aerosol-former. Examples of aerosol-formers include polyhydric alcohols and mixtures thereof such as glycerine or propylene glycol. Typically, the aerosol generating substrate may comprise an aerosol-former content of between approximately 5% and approximately 50% on a dry weight basis. In some embodiments, the aerosol generating substrate may comprise an aerosol-former content of between approximately 10% and approximately 20% on a dry weight basis, and possibly approximately 15% on a dry weight basis.

Upon being heated by the first or second inductively heatable susceptor, the aerosol generating substrate may release volatile compounds. The volatile compounds may include nicotine or flavour compounds such as tobacco flavouring.

According to a third aspect of the present disclosure, there is provided a method of using an aerosol generating system as defined above, the method comprising:
positioning at least part of the aerosol generating substrate in a heating chamber of the aerosol generating device:
actuating, by the controller, the induction heating arrangement to supply an alternating electric current to the plurality of first coil strands for a first period of time to generate the first electromagnetic field for the first period of time to heat a first portion of the aerosol generating substrate:
actuating, by the controller, the induction heating arrangement to supply an alternating electric current to the plurality of second coil strands for a second period of time which follows the first period of time to generate the second electromagnetic field for the second period of time to heat a second portion of the aerosol generating substrate.

The first electromagnetic field may cause preferential heating of a first inductively susceptor during the first period of time and the second electromagnetic field may cause preferential heating of a second inductively heatable susceptor during the second period of time. Thus, the first inductively heatable susceptor may be heated to a higher temperature than the second inductively heatable susceptor during the first period of time whereas the second inductively heatable susceptor may be heated to a higher temperature than the first inductively heatable susceptor during the second period of time. As noted above, this provides for controlled heat distribution within the aerosol generating substrate and, in particular, provides for selective (or “zonal”) heating.

In an embodiment of the method, the heating chamber may define a heating zone. The step of actuating, by the controller, the induction heating arrangement to supply the alternating electric current to the plurality of first coil strands may cause the generated first electromagnetic field to heat a first inductively heatable susceptor that defines a first area of the heating zone in which the first portion of the aerosol generating substrate is positioned. The step of actuating, by the controller, the induction heating arrangement to supply the alternating electric current to the plurality of second coil strands may cause the generated second electromagnetic field to heat a second inductively heatable susceptor that defines a second area of the heating zone in which the second portion of the aerosol generating substrate is positioned.

The method thus provides for selective (or “zonal”) heating of the aerosol generating substrate in the first and second areas. In particular, the first portion of the aerosol generating substrate positioned in the first area is heated by the first inductively heatable susceptor and the second portion of the aerosol generating substrate positioned in the second area is heated by the second inductively heatable susceptor. As noted above, the heating of the first and second portions of the aerosol generating substrate is typically sequential.

### BRIEF DESCRIPTION OF THE DRAWINGS

FIG. 1 is a diagrammatic cross-sectional view of an aerosol generating system comprising an aerosol generating device and an aerosol generating article ready to be positioned in a heating chamber of the aerosol generating device:

FIG. 2 is a diagrammatic cross-sectional view of the aerosol generating system of FIG. 1, showing the aerosol generating article positioned in the heating chamber of the aerosol generating device:

FIG. 3 is a detailed diagrammatic perspective view of the heating chamber of the aerosol generating device of FIGS. 1 and 2, showing first and second inductively heatable susceptors mounted on an inner surface of the heating chamber and a coil support structure:

FIG. 4 is a diagrammatic cross-sectional view from an end of the heating chamber shown in FIG. 3, showing first and second inductively heatable susceptors spaced around a periphery of the heating chamber; and

FIG. 5 is a diagrammatic perspective view of an induction coil of the aerosol generating device showing first and second coil portions within a cross-sectional coil envelope of the induction coil.

### DETAILED DESCRIPTION OF EMBODIMENTS

Embodiments of the present disclosure will now be described by way of example only and with reference to the accompanying drawings.

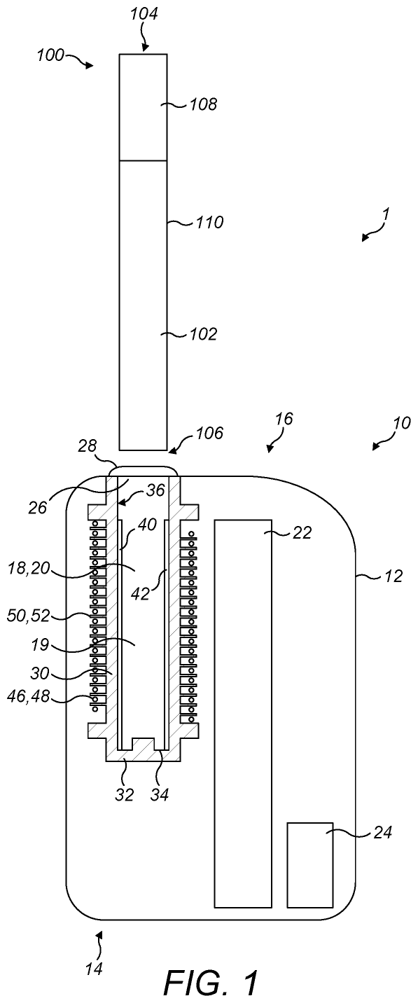

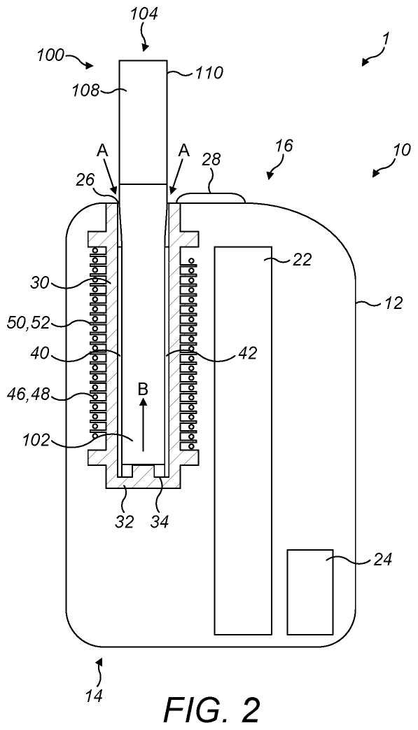

Referring initially to FIGS. 1 and 2, there is shown diagrammatically an example of an aerosol generating system 1. The aerosol generating system 1 comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines a heating zone 19 within an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise heat transfer to the main body 12.

The aerosol generating device 10 can optionally include a sliding cover 28 movable transversely between a closed position (see FIG. 1) in which it covers the open first end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a center hole segment and a filter segment. The cooling segment typically comprises a hollow paper tube having a thickness which is greater than the thickness of the wrapper 110. The center hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the center hole segment to form an aerosol with suitable characteristics for inhalation by a user through the filter segment.

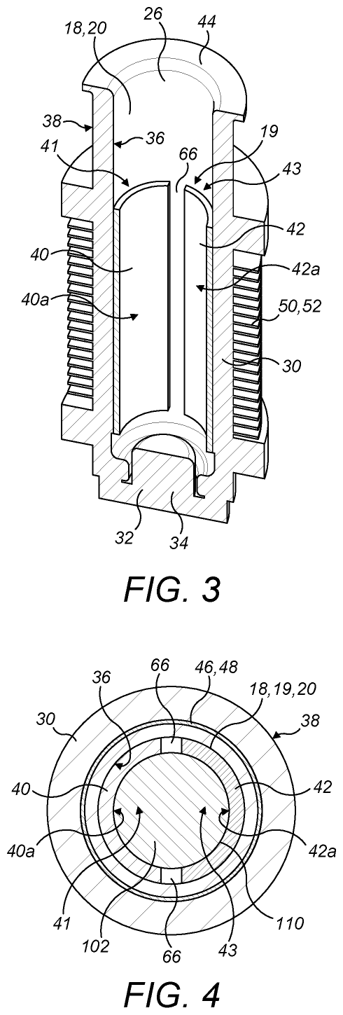

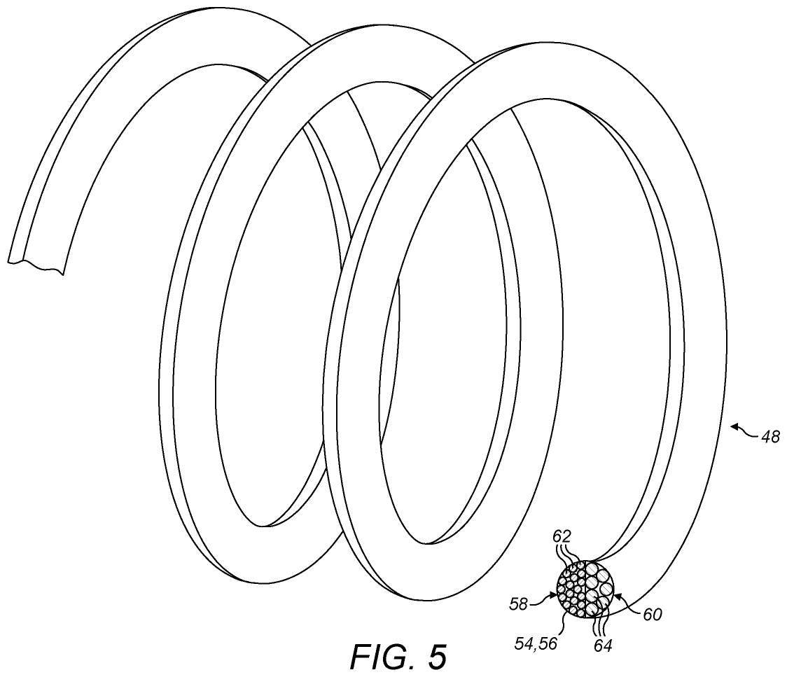

Referring also to FIGS. 3 and 4, the heating chamber 18 has a side wall (or chamber wall) 30 extending between a base 32, located at a second end 34 of the heating chamber 18, and the open first end 26. The side wall 30 and the base 32 are connected to each other and can be integrally formed as a single piece. In the illustrated embodiment, the side wall 30 is tubular and, more specifically, cylindrical. In other embodiments, the side wall 30 can have other suitable shapes, such as a tube with an elliptical or polygonal cross section. In yet further embodiments, the side wall 30 can be tapered.

In the illustrated embodiment, the base 32 of the heating chamber 18 is closed, e.g., sealed or air-tight. That is, the heating chamber 18 is cup-shaped. This can ensure that air drawn from the open first end 26 is prevented by the base 32 from flowing out of the second end 34 and is instead guided through the aerosol generating substrate 102. It can also ensure that a user inserts the aerosol generating article 100 into the heating chamber 18 an intended distance and no further.

The side wall 30 of the heating chamber 18 has an inner surface 36 and an outer surface 38. The aerosol generating device 10 comprises first and second inductively heatable susceptors 40, 42 mounted on the inner surface 36 of the side wall 30 within the heating zone 19. In the illustrated example, each of the first and second inductively heatable susceptors 40, 42 circumscribes an angle of just less than 180° and, thus, together the first and second inductively heatable susceptors 40, 42 extend substantially around the entire inner surface 36 of the side wall 30 in the circumferential direction. The first inductively heatable susceptor 40 defines a first area 41 for heating within the heating zone 19 and the second inductively heatable susceptor 42 defines a second area 43 for heating within the heating zone 19.

The first and second inductively heatable susceptors 40, 42 are elongate in the longitudinal direction of the heating chamber 18. Each of the first and second inductively heatable susceptors 40, 42 has a length and a width, and typically the length is at least five times the width. It will be understood by one of ordinary skill in the art that the first and second inductively heatable susceptors 40, 42 are not limited to the geometries shown in FIGS. 3 and 4 and that other geometries are entirely within the scope of the present disclosure.

The first and second inductively heatable susceptors 40, 42 each have an inner surface 40a, 42a which contacts the aerosol generating substrate 102. The first and second inductively heatable susceptors 40, 42 may form a friction fit with the aerosol generating substrate 102, and more particularly with the wrapper 110 of the aerosol generating article 100, and may cause compression of the aerosol generating substrate 102 as best seen in FIG. 2. The compression of the aerosol generating substrate 102 improves thermal conduction through the aerosol generating substrate 102, for example by eliminating air gaps within the aerosol generating substrate 102.

The aerosol generating device 10 comprises an induction heating arrangement 46 for heating the aerosol generating substrate 102. The induction heating arrangement 46 comprises a substantially helical induction coil 48. The induction coil 48 extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The side wall 30 of the heating chamber 18 includes a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to the first and second inductively heatable susceptors 40, 42.

Referring now to FIG. 5, the induction coil 48 comprises a coil periphery 54 when viewed in cross-section, the coil periphery 54 defining a cross-sectional coil envelope 56. An outer insulation (not shown) may surround the coil periphery 54. Within the cross-sectional coil envelope 56, there is a first coil portion 58 and a second coil portion 60 which is electrically isolated from the first coil portion 58. The first coil portion 58 comprises a plurality of first coil strands 62 and the second coil portion 60 comprises a plurality of second coil strands 64. In the illustrated example, the first coil strands 62 have a first cross-sectional area and the second coil strands 64 have a second cross-sectional area which is larger than the first cross-sectional area. This arrangement is not, however, compulsory, and it may be sufficient if the first coil strands 62 have a first cross-section and the second coil strands 64 have a second cross-section which differs from the first cross-section. Here, the term cross-section can include one or more of cross-sectional area and cross-sectional shape. It should also be noted that the first and second coil portions 58, 60 do not have to be semi-circular as depicted in FIG. 5 and that other arrangements are possible, such as a concentric arrangement of the first and second coil portions 58, 60.

In order to use the aerosol generating device 10, a user displaces the sliding cover 28 (if present) from the closed position shown in FIG. 1 to the open position shown in FIG. 2. The user then inserts an aerosol generating article 100 through the open first end 26 into the heating chamber 18, so that the aerosol generating substrate 102 is received in the heating zone 19 defined by the cavity 20 and so that the proximal end 104 of the aerosol generating article 100 is positioned at the open first end 26 of the heating chamber 18, with at least part of the mouthpiece segment 108 projecting from the open first end 26 to permit engagement by a user's lips.

Upon activation of the aerosol generating device 10 by a user, the induction heating arrangement 46 is energised by the power source 22 and controller 24. More specifically, and in accordance with the present disclosure, the controller 24 is configured to control the induction heating arrangement 46, and more particularly the power source 22 and control circuitry, to supply an alternating electric current to the plurality of first coil strands 62 in the first coil portion 58 to generate a first electromagnetic field with a first frequency and to supply an alternating electric current to the plurality of second coil strands 64 in the second coil portion 60 to generate a second electromagnetic field with a second frequency.

The first and second inductively heatable susceptors 40, 42 have different resonant frequencies. The first electromagnetic field with the first frequency causes preferential heating of the first inductively heatable susceptor 40 (by virtue of eddy currents and/or magnetic hysteresis losses generated in the first inductively heatable susceptor 40), and thus preferential heating of a first portion of the aerosol generating substrate 102 that is positioned in the first area 41 of the heating zone 19 by heat transferred from the first inductively heatable susceptor 40. The second electromagnetic field with the second frequency causes preferential heating of the second inductively heatable susceptor 42 (by virtue of eddy currents and/or magnetic hysteresis losses generated in the second inductively heatable susceptor 42), and thus preferential heating of a second portion of the aerosol generating substrate 102 that is positioned in the second area 43 of the heating zone 19 by heat transferred from the second inductively heatable susceptor 42. Thus, selective (or “zonal”) heating of first and second portions of the aerosol generating substrate 102 is achieved in the first and second areas 41, 43 within the heating zone 19. When the aerosol generating substrate 102 is heated by the first or second inductively heatable susceptor 40, 42, it results in heating of the aerosol generating substrate 102 without combustion or burning, and a vapour is thereby generated. The generated vapour cools and condenses to form an aerosol which can be inhaled by a user of the aerosol generating device 10 through the mouthpiece segment 108, and more particularly through the filter segment.

The controller 24 is typically configured to supply the alternating electric current to the plurality of first coil strands 62 in the first coil portion 58 for a first period of time to generate the first electromagnetic field (with its first frequency) for the first period of time. Thereafter, the controller 24 is typically configured to supply the alternating electric current to the plurality of second coil strands 64 in the second coil portion 60 for a second period of time to generate the second electromagnetic field (with its second frequency) for the second period of time. Thus, the supply of alternating electric current to the plurality of first coil strands 62 and to the plurality of second coil strands 64 is sequential, rather than simultaneous, so that the generation of the first and second electromagnetic fields (with their corresponding first and second frequencies) is also sequential. Thus, during the first period of time, the first inductively heatable susceptor 40 is preferentially heated by the first electromagnetic field and during the second period of time, the second inductively heatable susceptor 42 is preferentially heated by the second electromagnetic field. This provides for sequential, and thus selective (or “zonal”), heating of first and second portions of the aerosol generating substrate 102 that are positioned respectively in the first and second areas 41, 43 within the heating zone 19.

The vaporisation of the aerosol generating substrate 102 is facilitated by the addition of air from the surrounding environment, for example through the open first end 26 of the heating chamber 18, the air being heated as it flows between the wrapper 110 of the aerosol generating article 100 and the inner surface 36 of the side wall 30 where there is a circumferential spacing between longitudinal edges of the first and second inductively heatable susceptors 40, 42. More particularly, when a user sucks on the filter segment, air is drawn into the heating chamber 18 through the open first end 26 as illustrated by the arrows A in FIG. 2. The air entering the heating chamber 18 flows from the open first end 26 towards the closed second end 34, between the wrapper 110 and the inner surface 36 of the side wall 30. As noted above, the inner surfaces 40a, 42a of the first and second inductively heatable susceptors 40, 42 may contact the outer surface of the aerosol generating article 100, and may typically cause at least some degree of compression of the aerosol generating substrate 102. Consequently, there is no air gap all the way around the heating chamber 18 in the circumferential direction. Instead, there are air flow paths 66 in the circumferential regions (two gap regions) between the longitudinal edges of the first and second inductively heatable susceptors 40, 42 along which air flows from the open first end 26 towards the closed second end 34 of the heating chamber 18. In some examples, more than two inductively heatable susceptors 40, 42 may be employed and, thus, a corresponding number of air flow paths 66 may be formed by gap regions between the longitudinal edges of circumferentially adjacent inductively heatable susceptors. When the air reaches the closed second end 34 of the heating chamber 18, it turns through approximately 180° and enters the distal end 106 of the aerosol generating article 100. The air is then drawn through the aerosol generating article 100 as illustrated by the arrow B in FIG. 2, from the distal end 106 towards the proximal (mouth) end 104 along with the generated vapour.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

The invention has been described above with reference to an example in which the first coil strands differ from the second coil strands in cross-sectional area. However, it will be appreciated that the first coil strands could differ from the second coil strands in another way, if desired. For example, the first coil strands could have a different cross-sectional shape (as well as or instead of a different cross-sectional area) and/or could be formed from a different material to the second coil strands in order to generate the differing first and second electromagnetic fields. It will further be appreciated that the first coil strands could be the same as the second coil strands (i.e. have the same cross-section and material) and instead the first coil strands could be energized by the controller with a different alternating current to the second coil strands in order to generate the differing first and second electromagnetic fields. In any of these cases, the first coil strands are electrically isolated from the second coil strands (e.g. separated by an insulator) as described above, in order to ensure that the coil portions are substantially independently energizable.

Unless the context clearly requires otherwise, throughout the description and the claims, the words “comprise”, “comprising”, and the like, are to be construed in an inclusive as opposed to an exclusive or exhaustive sense: that is to say, in the sense of “including, but not limited to”.

1. An aerosol generating device comprising:
a controller;
an induction heating arrangement configured to heat an aerosol generating substrate to generate an aerosol to be inhaled, the induction heating arrangement comprising an induction coil comprising at least a plurality of first coil strands and a plurality of second coil strands;
wherein the controller is configured to control the induction heating arrangement to supply an alternating electric current to the plurality of first coil strands to generate a first electromagnetic field with a first frequency and to supply an alternating electric current to the plurality of second coil strands to generate a second electromagnetic field with a second frequency that is different from the first frequency.

2. The aerosol generating device according to claim 1, wherein the induction coil comprises a first coil portion in which the plurality of first coil strands are arranged and a second coil portion in which the plurality of second coil strands are arranged.

3. The aerosol generating device according to claim 2, wherein the induction coil comprises a periphery defining a cross-sectional coil envelope, and the first and second coil portions are arranged within the cross-sectional coil envelope.

4. The aerosol generating device according to claim 2, wherein the first and second coil portions are electrically isolated from each other.

5. The aerosol generating device according to claim 1, wherein the plurality of first coil strands have a first cross-section and the plurality of second coil strands have a second cross-section which differs from the first cross-section.

6. The aerosol generating device according to claim 5, wherein the plurality of first coil strands and the plurality of second coil strands differ from each other in one or more of cross-sectional shape and cross-sectional area.

7. The aerosol generating device according to claim 1, wherein the controller is configured to sequentially supply the alternating electric current to the plurality of first coil strands and the plurality of second coil strands to sequentially generate the first and second electromagnetic fields.

8. The aerosol generating device according to claim 1, wherein the controller is configured to supply the alternating electric current to the plurality of first coil strands for a first period of time to generate the first electromagnetic field for the first period of time and thereafter to supply the alternating electric current to the plurality of second coil strands for a second period of time that follows the first period of time to generate the second electromagnetic field for the second period of time.

9. The aerosol generating device according to claim 1, further comprising a heating chamber defining a heating zone for receiving at least part of an aerosol generating substrate and the induction coil is positioned adjacent to the heating chamber to generate the first and second electromagnetic fields within the heating zone.

10. The aerosol generating device according to claim 9, wherein the first electromagnetic field is adapted to heat a first inductively heatable susceptor having a first resonant frequency and the second electromagnetic field is adapted to heat a second inductively heatable susceptor having a second resonant frequency that is different from the first resonant frequency.

11. The aerosol generating device according to claim 10, further comprising a first inductively heatable susceptor and a second inductively heatable susceptor.

12. The aerosol generating device according to claim 11, wherein the first and second inductively heatable susceptors are positioned around the heating chamber within the heating zone to define, respectively, a first area within the heating zone and a second area within the heating zone, and the induction coil extends helically around the heating chamber.

13. An aerosol generating system comprising:
an aerosol generating substrate; and
the aerosol generating device according to claim 1 for heating the aerosol generating substrate to generate an aerosol to be inhaled.

14. A method of using the aerosol generating system according to claim 13, the method comprising:
positioning at least part of the aerosol generating substrate in a heating chamber of the aerosol generating device;
actuating, by the controller, the induction heating arrangement to supply an alternating electric current to the plurality of first coil strands for a first period of time to generate the first electromagnetic field for the first period of time to heat a first portion of the aerosol generating substrate;
actuating, by the controller, the induction heating arrangement to supply an alternating electric current to the plurality of second coil strands for a second period of time which follows the first period of time to generate the second electromagnetic field for the second period of time to heat a second portion of the aerosol generating substrate.

15. The method according to claim 14, wherein
the heating chamber defines a heating zone;
the step of actuating, by the controller, the induction heating arrangement to supply the alternating electric current to the plurality of first coil strands causes the generated first electromagnetic field to heat a first inductively heatable susceptor that defines a first area of the heating zone in which the first portion of the aerosol generating substrate is positioned; and
the step of actuating, by the controller, the induction heating arrangement to supply the alternating electric current to the plurality of second coil strands causes the generated second electromagnetic field to heat a second inductively heatable susceptor that defines a second area of the heating zone in which the second portion of the aerosol generating substrate is positioned.
